(19) United States
(12) Patent Application Publication
(10) Pub. No.: US 2024/0380517 A1
(43) Pub. Date: Nov. 14, 2024

(54) Parallel Data Encoding and Decoding

(71) Applicant: APS Technology 1 LLC, Sandy, UT (US)

(72) Inventors: Jeffrey G. Ballif, Highland, UT (US); Chris Anderson, Sandy, UT (US)

(21) Appl. No.: 18/658,486

(22) Filed: May 8, 2024

Related U.S. Application Data
(60) Provisional application No. 63/464,885, filed on May 8, 2023.

(51) Int. Cl. H04L 1/00; H04L 69/22

(52) U.S. Cl. CPC H04L 1/0076; H04L 69/22

(57) ABSTRACT

Technology is described for parallel data encoding and decoding. The method can include receiving a first data block comprising a first plurality of encoded data packets and a second data block comprising a second plurality of encoded data packets. The first data block may be received by a service from a client over a packet network. The service may analyze the first plurality of encoded data packets and the second plurality of encoded data packets to identify a first encoder-decoder pair identifier and a second encoder-decoder pair identifier. The first encoder-decoder pair identifier may match a first client encoder with a first service decoder for the first data block, and the second encoder-decoder pair identifier may match a second client encoder with a second service decoder for the second data block. The first and second plurality of encoded data packets may be decoded using the first and second service decoders.

### PRIORITY DATA

This application claims the benefit of U.S. Provisional Patent Application Ser. No. 63/464,885, filed on May 8, 2023, which is incorporated herein by reference.

### BACKGROUND

Communications across computer networks have become a widely available form of communications. The communications can be between many forms of computing devices, including: mobile devices, servers, clients to servers, game consoles, desktop computers, laptops and a myriad of other computing devices. The form of data being sent in these communications usually takes the form of data packets which are transmitted across a computer network between the computing devices.

Data may be transmitted through the Internet using packets or chunks of information. Packet formatting and the method for delivering packets across the Internet are governed by a protocol known as TCP/IP (transmission control protocol/internet protocol). For a TCP data transmission to be completed, the recipient TCP layer may collect the packets and organize the packets in the order in which the packets were sent. If a packet is lost, the protocol interprets this as a sign that the network is congested—the transmission speed is immediately halved, and from there the packets speed attempts to increase again at a slow rate. This is beneficial in some situations and inefficient in other situations.

### BRIEF DESCRIPTION OF THE DRAWINGS

FIG. 1 is a block diagram illustrating an example of a source client that is the originator of data and the target client or server that receives the data.

FIG. 2 is a block diagram illustrating an example encoding and decoding using parallel encoders and decoders.

FIG. 3 is a flowchart illustrating an example of a method for parallel encoding and decoding.

FIG. 4 is a block diagram illustrating a computing device on which modules of this technology may execute.

### DETAILED DESCRIPTION OF THE PREFERRED EMBODIMENTS

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

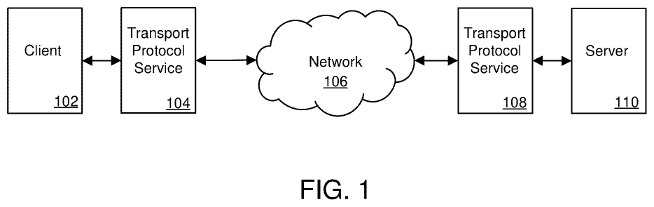

A technology is provided for improved efficiency of parallel encoding and decoding of data, which is encoded using RLNC (random linear network coding) encoding. FIG. 1 illustrates that a data stream may be sent between a client 102 and a server 110, and the data stream may comprise data packets sent and received over a network 106 (e.g., the internet) between the client 102 and the server 110. The client 102 and the server 110 may send and receive data packets to and from each other, which are encoded using random linear network coding (RLNC). The client 102 may be considered the source client and the server 110 may be considered the target client. The client and server may send data in either direction between the two systems.

In this technology, data to be sent may be received in the sending transport protocol service 104 and that data may be divided into multiple blocks of data. The sending transport protocol service 104 may be located on the client 102 or the sending transport protocol service 104 may be a separate service in the local network. The data may be a portion of a file, a segment of text, video, audio, data from a game, or other data. Each block of data may be encoded into RLNC by generating symbols. Each of the encoded blocks of symbols may be transmitted across the packet network. Examples of the packet network may be a local packet network (LAN), a wide area network (WAN) or the internet. Any type of packet network may be used, including TCP/IP (transmission control protocol/internet protocol). The packets may be received by a receiving transport protocol service 108 that can decode the blocks in the packets for the server 110.

Several encoded blocks of data can be processed and encoded or decoded simultaneously. This means, the first block of data sent by a sending client 102 does not need to be completely decoded at a server or receiving client before the next data block of symbols are processed and sent. Therefore, multiple blocks data symbols for the data can be sent across the packet network simultaneously.

This technology may provide parallel encoding and decoding. Initially a piece of data comes in and gets divided up into blocks. The blocks may be encoded, sent across the network and then decoded. It is possible that some blocks may be delayed or lost during transmission. In the past, when blocks were lost or delayed then this situation can also delay decoding of the blocks and delay the entire process, if performed serially. The present technology can perform encoding and decoding in parallel and multiple encodes and decodes are simultaneously performed to speed up the ability to obtain the final data.

In one embodiment, the number of encoding blocks grows when channel grows in bandwidth. In the past, an encoding service can encode a block and then send the block. Then the system may wait to hear that the block was received and decoded before moving on to next block for each block of data. In one example, the bandwidth of the channel may vary. A channel may range from small amount of data up to 1 gigabit or 10 gigabits per second.

A portion of a message to be sent may be a chunk of data. The chunk of data may be received from a client and may be encoded. What comes out is a large symbol that is encapsulated in a UDP packet and is sent across a network (e.g., the internet). The receiving side strips off the UDP packet and the symbol is input into a decoder and once the decoder has enough symbols, then the decoder can decode that portion of the message, and the original data is the output of the decoder. The symbol is coefficients in linear algebra in a sparse matrix, and the symbol size is about 1476 characters but it is variable.

The decoders have logic to decode the RLNC and the order in which the symbols are received does not affect the decoding using this technology, but the decoders can rebuild the symbols encoded by the sending side while multiple encoders and decoders are executing. The encoders and decoders may execute on one or many processors that are on a single device or spread out over multiple devices.

FIG. 1 illustrates that a client 102 may be the originator of data to be sent and the server 110 (e.g., target client) may receive the data. The transport protocol service 104 may be part of the client in this example. The data may alternatively flow from the server 110 to the client 102.

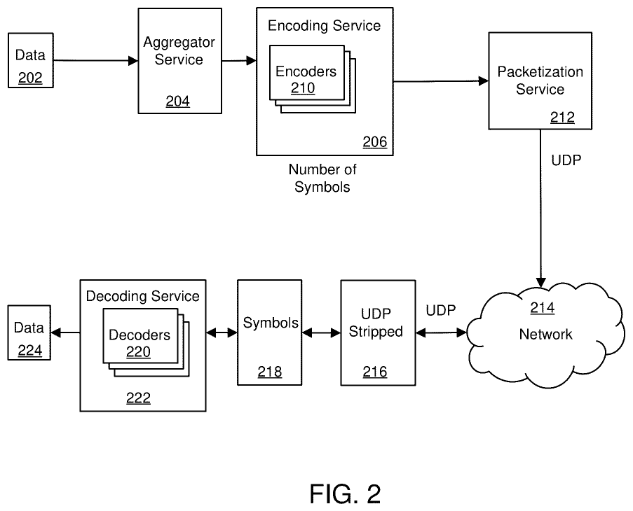

FIG. 2 illustrates that data 202 comes in and is aggregated together by an aggregator service 204. And the aggregator services accumulates a block, and the block may be sent to an encoder 210 in an encoding service 206. The encoder 210 may take the block and generate a symbol. The encoding service 206 is configured to know how big the symbol is or a total symbol size.

Once the encoder 210 has generated the symbols, the symbols can be formed into packets by a packetization service 212 and sent out in UDP packets to the network 214. The receiving service may also receive the UDP packets and strip the UDP packets 216 off the symbol data 218.

The decoder receiver or decoding service 222 on the receiving side then can receive a certain number of symbols 218 before decoding begins. If some data is lost in the middle (e.g., during network transit), the original packet does not need to be re-sent because the RLNC encoding can be used to rebuild that lost symbol. The decoding 222 service can obtain another symbol for the decoder and it does not matter which symbol is obtained. The decoder can keep building out the linear equations network so the decoder can look backwards to solve the symbols.

The decoder 220 will know in advance how many symbols 218 make a full block and how big the symbol size is. This allows the decoder 220 to know what is missing, and the decoder can use the data to solve the RLNC equations using a large matrix. Every line in the matrix may be filled up with random coefficients. The decoder can know the dimensions of the matrix and the data in the matrix is the coefficients for the matrix. As mentioned, some of the coefficients may be lost due to data loss across wireless networks or the internet.

Inside the symbol data is information about the block number the data is from, how many symbols are necessary and what the symbol size is. The values in these variables may vary depending on how much data is provided. The size of the block is the number of symbols times/multiplied by the symbol size and the decoder knows this information in advance.

For decoding to occur, an encoder 210 has to match a decoder 220. Thus, the information from encoder 1 may be sent to decoder 1 and the information from encoder 2 may be sent to decoder 2, and so on. The encoder and decoder value can be encoded with data as part of the symbol. There may be a header inside the UDP packet of the symbol so a decoding service 222 may know which decoder 220 the symbol can be routed to.

In comparison to previously existing parallel processing communication systems, such systems have generic CPUs and/or servers and the CPUs are data agnostic. Parallel processing of data may describe which part of the data the next chunk belongs to but it does not matter which processor the data goes to. However, in this technology the encoders 210 and decoders 220 are matched using the sequence number because it does matter which decoder receives the information encoded by specific decoder because otherwise the RLNC decoding will be scrambled and will fail.

In one example, the decoder 220 may send a message back to state that six symbols have been received but the encoder 210 knows it needs seven symbols to complete the series. So, the encoder 210 knows to send the seventh symbol. If encoder 210 does not get a message from the decoder 222 in time (e.g., before a time-out) then the encoder 210 goes ahead and sends another set of symbols. If the block is 7 by 1476 bytes then seven symbols must be sent. When a block is encoded, a useful number (e.g., an optimized number) of symbols and symbol size is chosen. Frequently, the symbol size may be maximized up to the maximum transmission unit (MTU) (i.e., the largest packet or protocol data unit (PDU) that can be communicated in a single network layer transaction) of the network interface and the number of symbols can be adjusted to create a block size that is big enough to include the data to be transported. This information can be sent to the other side with the symbol. There may be latency across computer networks and especially in a long distance network (e.g., sending across world takes significant time). The encoder 210 may send seven symbols right off the bat assuming the decoder 222 will receive them. Whenever the decoder 222 receives a symbol the decoder 222 replies that that symbol was received. Once the decoder 222 says seven symbols were received then the message is complete and can be decoded.

The number of symbols sent on the network for any given connection may be limited to 80/MaxOutBlocks. Being able to send a larger number of symbols allows for better performance over long latencies. The number 80 may be a configurable number (MaxOutBlocks) that can set at run time, where 80 is the default.

The number of symbols sent by each encoder 210 may also be managed by considering fairness between the multiple encoders 210. Accordingly, the number of symbols in each message may be set at a number to allow each of the encoders to send their messages on an equal basis.

In one example, the entire encoder pool 206 or decoder pool 222 can be executing using a single process or thread. There may also be a pool of encoders with N encoders on the sending side and a pool of decoders on the receiving side with N decoders. Each encoder may have a corresponding decoder.

Alternatively, each encoder 210 or decoder 220 in a pool can have a separate process or processor to be able execute on a CPU or server, if the processing hardware is available. Providing a separate thread or a separate CPU for each encoder 210 or decoder 220 can help avoid bottlenecks that might occur using one processor or thread for a group of encoders 210 or decoders 220. Some encoders 210 or decoders may share a processor or thread in groups of two or three, etc.

In a further embodiment, a pool of threads may be available and decoders 220 may have symbols that needs to be decoded. As a result, the threads in the pool can be used by the decoders 220 and assigned to the decoders 220 as needed but not before the need arises. The threads may not be initially assigned to decoders but the threads may be assigned when the actual processing is needed. This configuration may multiplex the threads to avoid waiting for a thread once the symbol is received by the decoder 220. This may be event driven and a decoder 220 may not have to wait unless a thread is not available. Multiplexing of threads may allow the encoders 210 or decoders 220 to use two processor cores, four processor cores or as many processor cores as are available in the hardware.

Matching the encoder 210 to a decoder 220 and managing those pairings helps to keep the network path full and improve decoding performance. Specifically, matching of the encoder 210 to a decoder 220 helps overcomes latency issues rooted in waiting for decoders 220 to reply that they have received the symbols. For example, when certain encoders 210 are blocked and are waiting for decoders to reply that symbols have been received, then other decoders may use the bandwidth to send their symbols. This means that some of the encoding and decoding processes may provide users with lower bandwidth at one point when the process is blocked and then later provide a higher level of bandwidth when not blocked, so the overall available bandwidth can be kept full.

The symbol size being sent in a message may change based on the data available when encoding starts but not as the bandwidth changes. For example, if the data being sent is short snippets of typing, then a big symbol size per message is not needed and may be wasteful. However, if a large file is to be sent then a larger symbol size may make more sense. Accordingly, symbol size may be determined initially based on the size of the data to be sent. The use of a small symbol size is lower in overhead. In addition, a block of data can be closed off if no response is received from a decoder and then send all of that data may be re-sent. While a large symbol size is generally helpful, the message may be restricted to the MTU to avoid IP fragmentation.

The data to be sent may be queued up for encoding. The data being sent can be encoded and sent as fast as possible by the encoder 210. For each symbol sent, the encoder 210 does not have to wait through latency for the receiver to respond. So, the data is divided into chunks and each encoder 210 gets a time slot when the network is ready and has available bandwidth. After an initial portion of the message is sent then the next portion of the message may be sent depending on what response is received back from decoder 220 (e.g. in a receiver). However, after certain amount of time if nothing has been sent back from the receiver or decoder 220 then the encoder 210 goes ahead and sends additional portions of the message (i.e., additional symbols). Because of latency, this delay and sending process may occur across multiple blocks of data. The bottleneck is waiting for the confirmation from the receiver. To avoid this bottleneck, many encoders 210 may be used which may be ready to send data at different times to many decoders 220.

In the example case, where many encoders 210 are executing using a single thread, the issue of blocking while waiting for acknowledgements may be mitigated. One thread may be able to service many encoders because of the issue where one or more encoders may be blocked waiting for an acknowledgement (e.g., an ACK message) but other encoders 210 are ready to send; and so, the bottleneck is reduced. Thus, a single thread may be able to simulate many encoders 210 sending symbols in parallel because some encoders 210 are likely to be blocked at any given time.

This technology may minimize the effect of latency over the network that results from decoding the RLNC encoding. By comparison, TCP/IP (transmission control protocol/internet protocol) is a different because the TCP/IP protocol will re-send lost or unreceived packets. This technology does not resend the same packets because it does not need to. Lost or missing packets can be rebuilt using RLNC. Instead, new symbols can be sent that are different but are a new encoding of the same block of data. For example, if the decoder and receiver come back and confirm receipt of 3 symbols but the encoder sent 7 symbols initially, then the encoder can now send 4 new symbols because 7 symbols are needed to reconstruct the entire 11 symbols. The number of 7 symbols is an example but the technology may uses anywhere from 1 to 25 symbols for the re-construction. Once the decoder has enough symbols then the decoder can obtain the data from the message.

An encoding module can encode data packets using random linear network coding and a decoding module can decode data packets encoded using random linear network coding. Traditional TCP/IP transmission divides data content into sequentially numbered packets and sends each packet with its accompanying sequence number. If a packet (i) does not arrive at its destination and therefore an acknowledgement is not sent to the origin or (ii) an acknowledgement is sent but does not arrive at the origin within a specific window of time, then the packet is resent. In random linear network coding (RLNC), data is divided into data blocks and the data blocks are encoded into symbols that include coded data packets. Each coded data packet is formed by multiplying each data block with a constant chosen randomly from a finite range of constants and then combining the results. Thus, each coded data packet can be represented by a linear equation in the following form:

$$\begin{matrix}CDP 1 = {C}_{1 , 1} \times {DB}_{1 , 1} + {C}_{1 , 2} \times {DB}_{1 , 2} + … + {C}_{1 , m} \times {DB}_{1 , m} \\ CDP 2 = {C}_{2 , 1} \times {DB}_{2 , 1} + {C}_{2 , 2} \times {DB}_{2 , 2} + … + {C}_{2 , m} \times {DB}_{2 , m} \\ CDP k = {C}_{k , 1} \times {DB}_{k , 1} + {C}_{k , 2} \times {DB}_{k , 2} + … + {C}_{k , m} \times {DB}_{k , m}\end{matrix}$$

Here, CDP represents a “coded data packet,” DB represents a “data block,” and C represents a randomly chosen constant from a finite range of constants.

The randomly chosen constant C_{k,m} multiplied with each data block are encoded in the headers of the coded data packets in which they are used. Assuming there are n data blocks to be sent, coded data packets are sent continuously until n distinct (i.e., linearly independent) coded data packets are received and acknowledged. Once n distinct coded data packets are received, they can be decoded to find the n data blocks. Alternatively, some individual coded data packets can be decoded as they are received. For example, given m distinct coded data packets encoded using a total of p unique data blocks, where m≥p, it is possible to decode the m coded data packets to find the p data blocks.

The number of symbols used to generate an encoded data block for a coded data packet can vary. In certain situations, it is advantageous to encode a coded data packet with a larger set of symbols (i.e., a larger number of symbols). For example, when the data loss rate in the network reaches a certain threshold, sending a coded data packet with a larger set of data blocks encoded into symbols is desirable because each distinct coded data packet received will contain more symbols that can be decoded into data blocks. Thus, in one embodiment, the encoding module increases the number of symbols used to encode a data block that may be included in a coded data packet in response to a data traffic measurement module. In other situations, it is advantageous to encode data blocks to symbols to be included in a coded data packet with a smaller set of symbols (i.e., a smaller number of symbols). An increase in the number of symbols with data blocks leads to an increase in packet header size (due to a corresponding increase in the number of constants C_{k,m} encoded in the packet header) and packet payload size, as well as increases in time used to encode and decode the symbols. Thus, when the data loss rate in the network is very low, sending a coded data packet with a smaller set of symbols is desirable because it reduces the overhead associated with encoding a larger number of symbols encoded into data blocks.

As explained above, random linear network coding (RLNC) adds overhead in terms of time required to encode and decode the coded data packets, as well as an increase in the size of the coded data packet header to include the randomly chosen constants. But the overhead incurred is typically small compared to the efficiency gained by the transmitter (e.g., the server or the client) in not having to retransmit lost coded data packets and the receiver (e.g., the server or the client) only having to acknowledge the receipt of every distinct coded data packet. Since it is possible that not all coded data packets created by random linear network coding are distinct, the transmitter may have to send more than n coded data packets in order for n distinct coded data packets to be received. Thus, if network congestion is low and there is very little to no packet loss, sending coded data packets encoded using random linear network coding may use more network bandwidth compared to encoding and sending data packets using the traditional TCP/IP transmission protocol.

A validation module may authenticate the client and determines whether the client possesses valid authorization to encode and decode data packets using random linear network encoding. In one embodiment, a control module causes the server and the client to send to and receive from each other data packets encoded using random linear network coding in response to the validation module authenticating the client and determining that the client possesses valid authorization. A database can store a unique identifier for each client. This identifier can be a unique alphanumeric code, picture, or other authentication token. For example, the stored identifier may be an encrypted hash of a client's MAC address. The database also stores an indicator of whether the client is authorized to encode or decode data packets using random linear network coding. In another embodiment, the control module may cause the server and the client to stop sending and receiving data packets encoded using random linear network coding between each other in response to the validation module determining that the client lacks valid authorization.

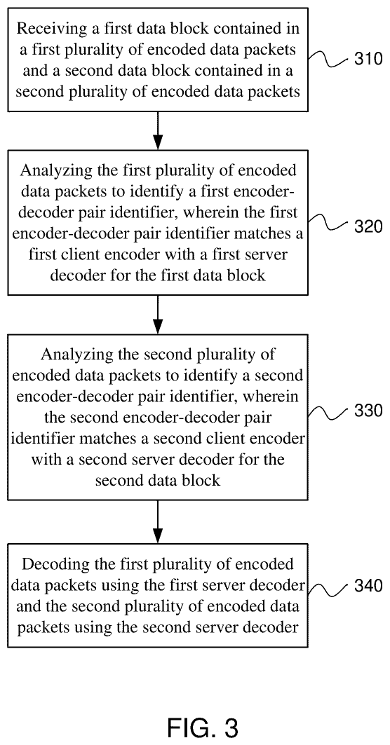

FIG. 3 illustrates a method for parallel encoding and decoding of data. The method may include receiving a first data block comprising a first plurality of encoded data packets and a second data block contained in a second plurality of encoded data packets, as in block 310. The first data blocks and second data blocks may be received at a service or server from a client over a packet network.

The first plurality of encoded data packets may be analyzed to identify a first encoder-decoder pair identifier, wherein the first encoder-decoder pair identifier matches a first client encoder with a first service decoder for the first data block, as in block 320. The encoded data packets may be analyzed at a server or service.

The second plurality of encoded data packets may be analyzed to identify a second encoder-decoder pair identifier, wherein the second encoder-decoder pair identifier matches a second client encoder with a second service decoder for the second data block, as in block 330. This analysis may also be performed at a server or service.

The first plurality of encoded data packets may be decoded using the first service decoder and the second plurality of encoded data packets using the second service decoder, as in block 340. The decoding may occur at a server, a service or another type of computing module.

The service may decode the first plurality of encoded data packets using the first service decoder in a first time window. In addition, the service may decode the second plurality of encoded data packets using the second service decoder in a second time window. This may be the sequential decoding of two different groups of encoded data packets using two separate computing processes or workers. Alternatively, the time window for decoding may also be the same for a first decoder and a second decoder, and this may provide parallel decoding.

When the decoding is initiated, a first user datagram protocol (UDP) header may be analyzed from a first UDP packet for the first plurality of encoded data packets to identify the first encoder-decoder pair identifier. The first encoder-decoder pair identifier may be a first data block number. For example, the first data block number may be the number one which represents the first data block was encoded by encoder one and should be decoded by decoder one. A second UDP header for a second UDP packet from the second plurality of encoded data packets may be analyzed to identify the second encoder-decoder pair identifier, and the second encoder-decoder pair identifier may be a second data block number.

The first plurality of encoded data packets and the second plurality of encoded data packets received as UDP packets over the packet network may also be decapsulated when received.

The service decoder can also acknowledge receipt of the symbols to the service encoder. For example, the first service decoder may send a first acknowledge message indicating total received symbols for the first plurality of encoded data packets to the first client encoder. Similarly, the second service decoder may send a second acknowledge message indicating total received symbols for the second plurality of encoded data packets to the second client encoder.

As discussed earlier, when symbols are not acknowledged as being received then additional symbols can be sent from the encoder(s). For example, a communications channel at the decoder service may listen for a third plurality of encoded data packets over the packet network when the total sent symbols for the first plurality of encoded data packets has not been received. The third plurality of encoded data packets may be associated with the first data block. The communications channel at the service may also listen for a fourth plurality of encoded data packets over the packet network when total sent symbols for the second plurality of encoded data packets has not been received. The fourth plurality of encoded data packets can be associated with the second data block.

The first plurality of encoded data packets, the second plurality of encoded data packets, or both comprise data fields representing at least one of: a total number of symbols, a symbol size, a sequence number, or a combination thereof. In addition, the first plurality of encoded data packets and the second plurality of encoded data packets may be encoded and decoded using random linear network coding (RLNC).

The encoder services and decoder services may maintain pools of encoders and decoders. For example, the first service decoder may be released when the first data block has been decoded and the second service decoder may be released when the second data block has been decoded. The encoder pool may operate by using encoders to encode data blocks and the encoders may be released to the encoder pool for later use.

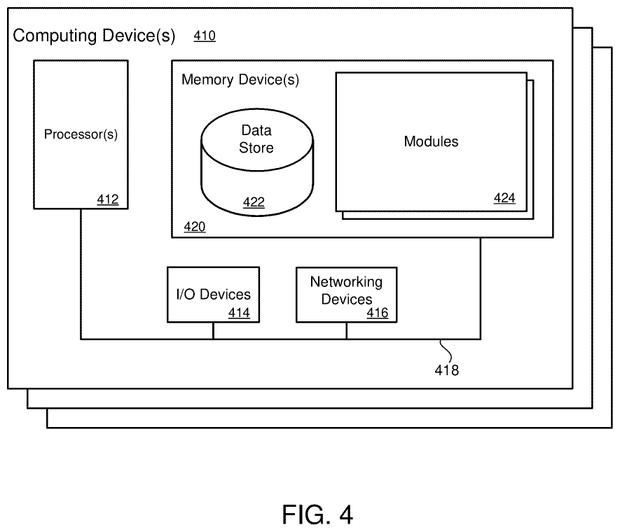

FIG. 4 illustrates a computing device 410 on which modules of this technology may execute. The computing device 410 is illustrated on which a high level example of the technology may be executed. The computing device 410 may include one or more processors 412 that are in communication with memory devices 420. The computing device may include a local communication interface 418 for the components in the computing device. For example, the local communication interface may be a local data bus and/or any related address or control busses as may be desired.

The memory device 420 may contain modules 424 that are executable by the processor(s) 412 and data for the modules 424. The modules 424 may execute the functions described earlier. A data store 422 may also be located in the memory device 420 for storing data related to the modules 424 and other applications along with an operating system that is executable by the processor(s) 412.

Other applications may also be stored in the memory device 420 and may be executable by the processor(s) 412. Components or modules discussed in this description that may be implemented in the form of software using high programming level languages that are compiled, interpreted or executed using a hybrid of the methods.

The computing device may also have access to I/O (input/output) devices 414 that are usable by the computing devices. An example of an I/O device is a display screen that is available to display output from the computing devices. Other known I/O devices may be used with the computing device as desired. Networking devices 416 and similar communication devices may be included in the computing device. The networking devices 416 may be wired or wireless networking devices that connect to the internet, a LAN, WAN, or other computing network.

The components or modules that are shown as being stored in the memory device 420 may be executed by the processor 412. The term “executable” may mean a program file that is in a form that may be executed by a processor 412. For example, a program in a higher level language may be compiled into machine code in a format that may be loaded into a random access portion of the memory device 420 and executed by the processor 412, or source code may be loaded by another executable program and interpreted to generate instructions in a random access portion of the memory to be executed by a processor. The executable program may be stored in any portion or component of the memory device 420. For example, the memory device 420 may be random access memory (RAM), read only memory (ROM), flash memory, a solid state drive, memory card, a hard drive, optical disk, floppy disk, magnetic tape, or any other memory components.

The processor 412 may represent multiple processors and the memory 420 may represent multiple memory units that operate in parallel to the processing circuits. This may provide parallel processing channels for the processes and data in the system. The local interface 418 may be used as a network to facilitate communication between any of the multiple processors and multiple memories. The local interface 418 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A computer implemented method, comprising:
receiving, at a service over a packet network, a first data block contained in a first plurality of encoded data packets and a second data block contained in a second plurality of encoded data packets;
analyzing, at the service, the first plurality of encoded data packets to identify a first encoder-decoder pair identifier, wherein the first encoder-decoder pair identifier matches a first client encoder with a first service decoder for the first data block;
analyzing, at the service, the second plurality of encoded data packets to identify a second encoder-decoder pair identifier, wherein the second encoder-decoder pair identifier matches a second client encoder with a second service decoder for the second data block; and
decoding, at the service, the first plurality of encoded data packets using the first service decoder and the second plurality of encoded data packets using the second service decoder.

2. The method of claim 1, further comprising:
decoding, at the service, the first plurality of encoded data packets using the first service decoder in a first time window and the second plurality of encoded data packets using the second service decoder in a second time window.

3. The method of claim 1, further comprising:
analyzing a first user datagram protocol (UDP) header for a first UDP packet from the first plurality of encoded data packets to identify the first encoder-decoder pair identifier, wherein the first encoder-decoder pair identifier is a first data block number; and
analyzing a second UDP header for a second UDP packet from the second plurality of encoded data packets to identify the second encoder-decoder pair identifier, wherein the second encoder-decoder pair identifier is a second data block number.

4. The method of claim 1, further comprising:
sending, from the first service decoder to the first client encoder, a first acknowledge message indicating total received symbols for the first plurality of encoded data packets; and
sending, from the second service decoder to the second client encoder, a second acknowledge message indicating total received symbols for the second plurality of encoded data packets.

5. The method of claim 1, further comprising:
listening, on a communications channel at the service, for a third plurality of encoded data packets over the packet network when total sent symbols for the first plurality of encoded data packets has not been received, wherein the third plurality of encoded data packets is associated with the first data block; or
listening, on the communications channel at the service, for a fourth plurality of encoded data packets over the packet network when total sent symbols for the second plurality of encoded data packets has not been received, wherein the fourth plurality of encoded data packets is associated with the second data block.

6. The method of claim 1, wherein the first plurality of encoded data packets, the second plurality of encoded data packets, or both comprise data fields representing at least one of: a total number of symbols, a symbol size, a sequence number, or a combination thereof.

7. The method of claim 1, further comprising decoding the first plurality of encoded data packets and the second plurality of encoded data packets using random linear network coding (RLNC).

8. The method of claim 1, further comprising decapsulating the first plurality of encoded data packets and the second plurality of encoded data packets as UDP packets received over the packet network.

9. The method of claim 1, further comprising releasing the first service decoder when the first data block has been decoded and the second service decoder when the second data block has been decoded.

10. A system for enhancing communications between a client and a service in a network, comprising:
at least one processor; and
a memory device including instructions that, when executed by the at least one processor, cause the system to:
receive, at the service from a client over a packet network, a first data block contained in a first plurality of encoded data packets and a second data block contained in a second plurality of encoded data packets;
analyze, at the service, the first and second plurality of encoded data packets to identify a first data block number that matches a first client encoder with a first service decoder for the first data block and a second data block number that matches a second client encoder with a second service decoder for the second data block;
decode, at the service, the first plurality of encoded data packets using the first service decoder; and
decode, at the service, the second plurality of encoded data packets using the second service decoder.

11. The system of claim 10, further comprising instructions, that when executed by the at least one processor, cause the system to:
decode the first plurality of encoded data packets using the first service decoder in a first time window; and
decode, at the service, the second plurality of encoded data packets using the second service decoder in a second time window, wherein the first time window overlaps with the second time window.

12. The system of claim 10, further comprising instructions, that when executed by the at least one processor, cause the system to:
send, from the first service decoder to the first client encoder, a first acknowledge message indicating total received symbols for the first plurality of encoded data packets; and
send, from the second service decoder to the second client encoder, a second acknowledge message indicating total received symbols for the second plurality of encoded data packets.

13. The system of claim 10, further comprising instructions, that when executed by the at least one processor, cause the system to:
listen, on a communications channel at the service, for a third plurality of encoded data packets over the packet network when total sent symbols for the first plurality of encoded data packets has not been received, wherein the third plurality of encoded data packets is associated with the first data block; or
listen, on the communications channel at the service, for a fourth plurality of encoded data packets over the packet network when total sent symbols for the second plurality of encoded data packets has not been received, wherein the fourth plurality of encoded data packets is associated with the second data block.

14. The system of claim 10, wherein the first plurality of encoded data packets, the second plurality of encoded data packets, or both comprise fields representing at least one of a total number of symbols, a symbol size, a sequence number, or a combination thereof.

15. The system of claim 10, further comprising instructions, that when executed by the at least one processor, cause the system to decode the first plurality of encoded data packets and the second plurality of encoded data packets using random linear network coding (RLNC).

16. The system of claim 10, further comprising instructions, that when executed by the at least one processor, cause the system to decapsulate the first plurality of encoded data packets and the second plurality of encoded data packets as first user datagram protocol (UDP) packets received over the packet network.

17. The system of claim 10, further comprising instructions, that when executed by the at least one processor, cause the system to release the first service decoder when the first data block has been decoded and the second service decoder when the second data block has been decoded.

18. A computer implemented method, comprising:
receiving, at a client from a service over a packet network, a first data block contained in a first plurality of encoded data packets and a second data block contained in a second plurality of encoded data packets;
analyzing, at the client, the first plurality of encoded data packets to identify a first encoder-decoder pair identifier, wherein the first encoder-decoder pair identifier matches a first service encoder with a first client decoder for the first data block;
analyzing, at the client, the second plurality of encoded data packets to identify a second encoder-decoder pair identifier, wherein the second encoder-decoder pair identifier matches a second service encoder with a second client decoder for the second data block; and
decoding, at the client, the first plurality of encoded data packets using the first client decoder and the second plurality of encoded data packets using the second client decoder.

19. The method of claim 18, further comprising:
decoding, at the client, the first plurality of encoded data packets using the first client decoder in a first time window and the second plurality of encoded data packets using the second client decoder in a second time window.

20. The method of claim 18, further comprising:
analyzing a first user datagram protocol (UDP) header for a first UDP packet from the first plurality of encoded data packets to identify the first encoder-decoder pair identifier, wherein the first encoder-decoder pair identifier is a first data block number; and
analyzing a second UDP header for a second UDP packet from the second plurality of encoded data packets to identify the second encoder-decoder pair identifier, wherein the second encoder-decoder pair identifier is a second data block number.

21. The method of claim 18, further comprising:
sending, from the first client decoder to the first service encoder, a first acknowledge message indicating total received symbols for the first plurality of encoded data packets; and
sending, from the second client decoder to the second service encoder, a second acknowledge message indicating total received symbols for the second plurality of encoded data packets.
